(19) United States
(12) Patent Application Publication
(10) Pub. No.: US 2007/0240642 A1
(43) Pub. Date: Oct. 18, 2007

(54) Substrate processing apparatus

(75) Inventors: Futoshi Shimai, Kanagawa (JP); Shigeru Kawata, Kanagawa (JP)

Correspondence Address: CARRIER BLACKMAN AND ASSOCIATES, 24101 NOVI ROAD, SUITE 100, NOVI, MI, 48375, US

(73) Assignee: Tokyo Ohka Kogyo Co., Ltd., Kawasaki-shi (JP)

(21) Appl. No.: 11/786,202

(22) Filed: Apr. 11, 2007

(30) Foreign Application Priority Data
Apr. 12, 2006 (JP) 2006-110147

(51) Int. Cl. B05B 7/06; B05B 1/28; B05C 13/02; B05C 13/00

(52) U.S. Cl. 118/313; 118/326; 118/58; 118/66

(57) ABSTRACT

A multi-stage substrate processing apparatus in which each processing stage is carried out on a substrate while conveying said substrate includes a processing liquid supply device and a drying device arranged successively along a conveying direction of the substrate. The drying device comprises an air knife for drying a processing liquid on the substrate. A plurality of nozzles for supplying the processing liquid onto the substrate are provided in the processing liquid supply device. At least the nozzle in the final stage among the plurality of nozzles is pointed in an opposite direction to the conveying direction of the substrate. This apparatus shortens tact time of the processed substrate.

### CROSS-REFERENCE TO RELATED APPLICATIONS

The present application claims priority from Japanese patent application 2006-110147, filed 12 Apr. 2006. The entire disclosure of the referenced priority document is incorporated herein by reference.

### BACKGROUND OF THE INVENTION

1. Field of the Invention

The present invention relates to a substrate processing apparatus for cleaning a substrate which is conveyed along a conveyance line.

2. Description of the Related Art

In the manufacturing process of liquid crystal panels or semiconductor devices, there is already known a process wherein various kinds of processing devices such as a wet unit, a dry unit, etc. are arranged along a substrate conveyance line to improve the processing efficiency with respect to substrates of various kinds and wherein various processing for the substrates is preformed while conveying the substrates by a conveyance roller (see patent reference 1, for example).

Further, there is also already known a process in which, for removing a residual processing liquid on a substrate so as to dry the substrate, an air knife is arranged just before a drying device (dry unit) in the stage following a developing device (wet unit) and a drying process step is carried out by the air knife, for example.

Patent reference 1: Japanese Patent Application Publication No. 2004-281991

In conveyance processing being currently put to practical use, there is a great demand for shortening tact time in various processing steps. However, when removing the residual processing liquid on the substrate merely by the processing with the air knife, there is a limit to the shortening of the tact time. Namely, in the case of removing the processing liquid sufficiently by the air knife, the conveyance speed must be reduced to lengthen time for jetting air to the substrate surface whereby time required for removal of the processing liquid increases. On the other hand, when shortening the processing time by the air knife, the processing liquid remains locally so that drying marks are generated.

Alternatively, it can be thought to increase air flow jetted from the air knife, but when the air flow is increased excessively, the processing liquid left on the substrate blows up and comes down again on the substrate. Therefore, there is a limit to increasing the air flow.

The cleaning device (wet unit), for example, is formed with a series of processing chambers (chambers) and a large amount of rinsing liquid is supplied from nozzles provided in each of the processing chambers, so that it is requested to decrease the consumption of the rinsing liquid by recycling the rinsing liquid used in each of the processing chambers.

### SUMMARY OF THE INVENTION

In view of the above-mentioned, an object of the present invention is to provide a substrate processing apparatus which is capable of sufficiently removing a residual processing liquid on a substrate and of shortening tact time.

Also, another object of the present invention is to provide a substrate processing apparatus which further improves recycling efficiency of a rinsing liquid.

In accordance with the present invention, a multi-stage substrate processing apparatus in which each processing stage is carried out on a substrate while conveying the substrate, comprises a processing liquid supply device, a drying device arranged in series with the processing liquid supply device along the conveying direction of the substrate, the drying device comprising an air knife for drying a processing liquid on the substrate, and a plurality of nozzles for supplying the processing liquid onto the substrate being provided in the processing liquid supply device, wherein at least the nozzle in the final stage among the plurality of nozzles is pointed in the opposite direction to the conveying direction of the substrate.

According to the substrate processing apparatus of the present invention, the processing liquid supply device and the drying device are arranged in sequence along the conveying direction of the substrate. The drying device comprises an air knife for drying a processing liquid on the substrate. A plurality of nozzles for supplying the processing liquid to the substrate are provided in the processing liquid supply device. At least the nozzle in the final stage among the plurality of nozzles is pointed in the opposite direction to the conveying direction of the substrate. With this construction, the residual processing liquid on the substrate is pushed back to a rear end side of the substrate by a liquid jetted from the nozzle. As a result, when the substrate is conveyed to the following drying device, the processing liquid left on the substrate, which is to be processed by the air knife, is small whereby the processing by the air knife can be carried out in a short time.

Further, in accordance with the present invention, a multi-stage substrate processing apparatus in which each processing stage is carried out on a substrate while conveying the substrate, comprises a processing liquid supply device including a plurality of processing chambers which are arranged in series along the conveying direction of the substrate, and a plurality of nozzles for supplying a processing liquid to the substrate being arranged in each of the processing chambers, wherein at least the nozzle in the final stage among the plurality of nozzles arranged in at least one of the processing chambers is pointed in the opposite direction to the conveying direction of the substrate.

According to the present invention, a processing liquid supply device is formed with a plurality of processing chambers which are arranged in series along the conveying direction of the substrate. A plurality of nozzles for supplying a processing liquid to the substrate are arranged in each of the processing chambers. At least the nozzle in the final stage among the plurality of nozzles arranged in one of the processing chambers is pointed in the opposite direction to the conveying direction of the substrate. Therefore, in the case where this construction is applied for example to a cleaning device with plurality of processing chambers, effects as referred to hereunder may be obtained.

Namely, since the cleaning device is constructed in such a manner that a nozzle in the final stage among a plurality of nozzles arranged in a first processing chamber is pointed in the opposite direction to the conveying direction of the substrate, a residual rinsing liquid (pure) on the substrate is pushed back to a rear end side of the substrate by a liquid jetted out of the nozzle so that the rinsing liquid left on the substrate remains within the first processing chamber. Therefore, it is possible to prevent the substrate from being conveyed to the following processing chamber in such a state that the rinsing liquid as contaminated adheres to the substrate. Thus, it is possible to prevent the contaminated rinsing liquid from entering and being mixed in successive processing chambers in the following stage.

As mentioned above, according to the substrate processing apparatus of the present invention, the processing by the air knife is capable of being carried out in a short time so that the substrate processing time (tact time) can be shortened. Also, according to the substrate processing apparatus of the present invention, it is possible to prevent the contaminated processing liquid (for example, rinsing liquid) from entering and being mixed in successive processing chambers in the following stage, so that when recycling the rinsing liquid in each of the processing chambers, a recycling rate of the rinsing liquid can be further improved.

### BRIEF DESCRIPTION OF THE DRAWINGS

FIG. 1 is a schematic structural view showing a substrate processing apparatus according to the present invention.

### DETAILED DESCRIPTION OF THE PREFERRED EMBODIMENTS

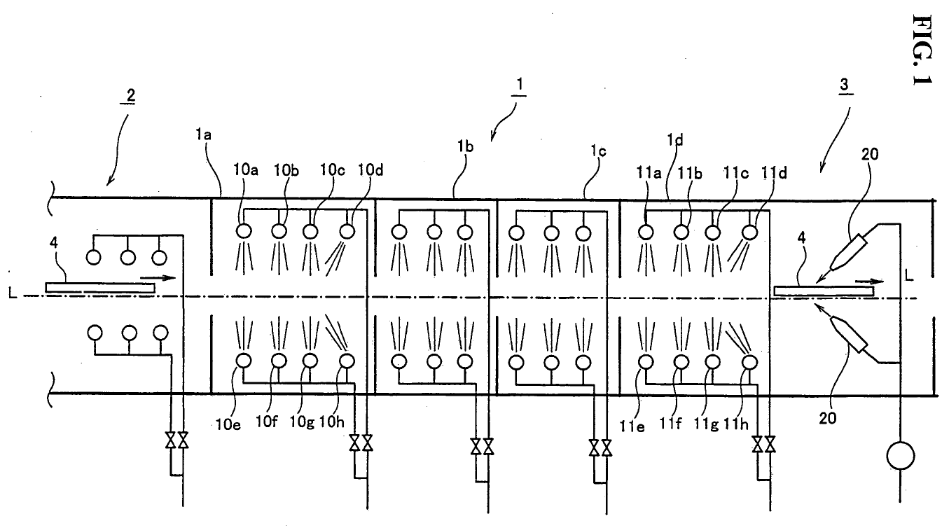

FIG. 1 is a schematic side view showing an embodiment of a substrate processing apparatus according to the present invention. In this embodiment, there is explained the substrate processing apparatus which is arranged between developing process and a drying process to clean and dry the substrate processed in the developing process.

The substrate processing apparatus comprises along a conveyance line L a developing device 2, a processing liquid supply device (cleaning device) 1 and a drying device 3 which are arranged each in given positions. A substrate 4 to be processed is conveyed from a left side to a right side of the drawing along the conveyance line L to be carried out in turn a developing processing, a cleaning processing and a drying processing. The drying device 3 comprises an air knife 20. This air knife 20 is provided for removing a rinsing liquid remaining on a surface of the substrate 4 and is formed to jet out air onto the substrate 4.

The cleaning device 1 is divided into a series of four processing chambers, namely cleaning units (1a-1d) so as to clean and remove a developing solution remaining on the substrate 4 by each of the cleaning units. The first cleaning unit 1a has, on the upper side of the substrate 4, nozzle groups (10a-10d) for example in four rows arranged in the direction of the conveyance line L. Each of the nozzle groups (10a-10d) is arranged along the direction crossing at a right angle the conveyance line L (width direction of the substrate, i.e. the direction crossing the drawing at a right angle). Similarly, on the lower side of the substrate 4 there are nozzle groups (10e-10h) for example in four rows arranged along the conveyance line L. Each of the nozzle groups (10e-10h) on the lower side is also arranged along the direction crossing the conveyance line L at a right angle. Herein, each of the nozzle groups is arranged with a predetermined width.

Each of cleaning nozzles on the upper and the lower sides is connected to a rinsing liquid supply pipe and a predetermined amount of rinsing liquid is supplied through the rinsing liquid supply pipe from a rinsing liquid tank (not shown). The predetermined amount of the rinsing liquid supplied is jetted out through the nozzle onto the surface of the substrate 4, whereby the developing solution remaining on the substrate surface is cleaned and removed.

Second, third, and fourth cleaning units 1b, 1c, 1d are formed substantially similar to the above, cleaning nozzle groups are arranged respectively on the upper side and on the lower side of the conveyed substrate 4 along the conveyance line L. The developing solution on the surface of the conveyed substrate 4 is cleaned by the rinsing liquid. In the drawing, the second and third cleaning units 1b, 1c have nozzle groups arranged each in three rows while the fourth cleaning unit 1d has nozzle groups arranged in four rows.

In this embodiment, particularly, a nozzle in a final stage among a plurality of nozzles is pointed in an opposite direction to the conveying direction of the substrate 4 (for example, 45 degrees-80 degrees).

In this embodiment, the plurality of nozzles as referred to herein are those which are provided within the fourth cleaning unit 1d among the plurality of cleaning units (1a-1d). Namely, a nozzle 11d in the final stage among a plurality of nozzles (11a-11d) provided within the fourth cleaning unit 1d is pointed in an opposite direction to the conveying direction of the substrate 4.

With this construction, the treatment of the rinsing liquid left on the surface of the substrate 4 using an air knife 20 can be shortened. Namely, in the pre-treatment for the air knife 20, the liquid jetted out of the nozzle 11d is possible to push the rinsing liquid on the substrate 4 back to the rear end side in the traveling direction of the substrate 4 so as to have the rinsing liquid fallen down within the fourth cleaning unit 1d. Thereby, the following drying process step by the air knife 20 can be shortened to a considerable extent in comparison for example with the case where the nozzle 11d is not pointed in the opposite direction to the conveying direction of the substrate 4. For example, in the conventional case where the pointing direction is not changed, the speed in the drying device 3 (air knife 20) was 50 mm/sec, while in the construction of this embodiment it was 70-100 mm/sec.

In the embodiment, although only the upper nozzle 11d is pointed to the opposite direction, when considering the back surface of the substrate 4, a nozzle 11h is also pointed to the similar direction, as shown in FIG. 1.

Next, another embodiment of the substrate processing apparatus according to the present invention will be explained hereunder.

The substrate processing apparatus of this embodiment is constructed by having only the cleaning device 1 arranged along the conveyance line of the substrate 4, without provision of the developing device 2 and the drying device 3 in the substrate processing apparatus as shown in FIG. 1. Herein, the construction of each of the devices is similar to the above-mentioned so that repeated explanation will be omitted.

In this embodiment, particularly, a nozzle 10d in a final stage among a plurality of nozzles (10a-10d) provided within the first cleaning unit 1a among the successive cleaning units (1a-1d) is pointed in an opposite direction to the conveying direction of the substrate 4.

With this construction, similar to the above mentioned case, for example the contaminated rinsing liquid on the surface of the substrate 4 can be prevented from entering and being mixed in the second cleaning unit 1b. Therefore, it is also possible to improve the recycling rate of the rinsing liquid.

Namely, in the cleaning device 1 is carried out the recycling as shown hereunder. Not shown in the drawing but there are three tanks (the first-the third) each reserving a rinsing liquid. First, a fresh liquid (new rinsing liquid) is supplied to the fourth cleaning unit 1d. Secondly, the rinsing liquid used in the fourth cleaning unit 1d is collected in the first tank thereby to be used in the third cleaning unit 1c. Then, the rinsing liquid used in the third cleaning unit 1c is collected in the second tank thereby to be used in the second cleaning unit 1b. Further, the rinsing liquid used in the second cleaning unit 1b is collected in the third tank thereby to be used in the first cleaning unit 1a. Then, lastly, the rinsing liquid used in the first cleaning unit 1a is discharged into a drain side. By carrying out the recycling like this, the consumption of the rinsing liquid is lessened.

However, in this case, the rinsing liquid to be used in the first cleaning unit 1a is the most contaminated rinsing liquid. Therefore, in the case where the substrate 4 is transferred from the first cleaning unit 1a to the second cleaning unit 1b, if the contaminated rinsing liquid remains on the substrate 4, such contaminated rinsing liquid enters and is mixed in the cleaning units (1b-1d) successive to the first cleaning unit 1a so as to result in a decline in the recycling rate.

However, in this embodiment, the final nozzle 10d among the plurality of nozzles (10a-10d) in the first cleaning unit 1a is pointed opposite to the conveying direction of the substrate 4. Therefore the rinsing liquid contaminated within the first cleaning unit 1a can be discharged into the drain side so that the contaminated rinsing liquid can be prevented from entering and being mixed in the second cleaning unit 1b. Then, since the rinsing liquid, which is collected in the cleaning units (1b-1d) following the first cleaning unit 1a, is prevented from being contaminated, the recycling rate of the rinsing liquid can be improved.

In this embodiment, although only the nozzle (nozzle group) 10d among the upper nozzle groups (10a-10d) is changed the direction thereof, the final nozzle (nozzle group) 10h among the lower nozzle groups (10e-10h) may be changed the direction thereof in like manner.

In each of the above-mentioned embodiments, the direction of the nozzle in each of the cleaning units is changed with respect to one nozzle in the upper side and one nozzle in the lower side. However, it is not limited to one nozzle each in the upper side and in the lower side, but the change in the direction may be made with respect to a plurality of nozzles in each of the upper and the lower sides.

It is to be understood that the present invention is not limited to the above-mentioned embodiments but may be otherwise variously modified without departing from the gist of the present invention.

1. A multi-stage substrate processing apparatus in which each processing stage is carried out on a substrate while conveying said substrate, comprising:
a processing liquid supply device;
a drying device arranged in series with said processing liquid supply device along a conveying direction of said substrate, said drying device comprising an air knife for drying a processing liquid on said substrate; and
a plurality of nozzles for supplying the processing liquid onto said substrate being provided in said processing liquid supply device,
wherein at least the nozzle in a final stage among the plurality of nozzles is pointed in an opposite direction to the conveying direction of said substrate.

2. A multi-stage substrate processing apparatus in which each processing stage is carried out on a substrate while conveying said substrate, comprising:
a processing liquid supply device having a plurality of processing chambers which are arranged in series along a conveying direction of said substrate; and
a plurality of nozzles for supplying a processing liquid to said substrate being arranged in each of said processing chambers,
wherein at least the nozzle in a final stage among the plurality of nozzles arranged in at least one of said processing chambers is pointed in an opposite direction to the conveying direction of said substrate.

3. The substrate processing apparatus according to claim 1, wherein two of the nozzles in the final stage among the plurality of nozzles are pointed in the opposite direction to the conveying direction of said substrate, one said nozzle pointed in the opposite direction supplies the processing liquid onto an upper surface of said substrate, and the other said nozzle pointed in the opposite direction supplies the processing liquid onto a lower surface of said substrate.

4. The substrate processing apparatus according to claim 1, wherein the nozzle pointed in the opposite direction supplies the processing liquid onto an upper surface of said substrate such that residual processing liquid remaining on the upper surface of the substrate is pushed back to a rear end side of the substrate by the supplied processing liquid.

5. The substrate processing apparatus according to claim 1, wherein others of the plurality of nozzles is pointed in an opposite substantially perpendicular to the conveying direction of said substrate.

6. The substrate processing apparatus according to claim 2, wherein two of the nozzles in the final stage among the plurality of nozzles are pointed in the opposite direction to the conveying direction of said substrate, one said nozzle pointed in the opposite direction supplies the processing liquid onto an upper surface of said substrate, and the other said nozzle pointed in the opposite direction supplies the processing liquid onto a lower surface of said substrate.

7. The substrate processing apparatus according to claim 2, wherein the nozzle pointed in the opposite direction supplies the processing liquid onto an upper surface of said substrate such that residual processing liquid remaining on the upper surface of the substrate is pushed back to a rear end side of the substrate by the supplied processing liquid.

8. The substrate processing apparatus according to claim 2, wherein others of the plurality of nozzles is pointed in an opposite substantially perpendicular to the conveying direction of said substrate.
